(19) United States
(12) Patent Application Publication
(10) Pub. No.: US 2016/0247187 A1
(43) Pub. Date: Aug. 25, 2016

(54) METERING REAL TIME SERVICE DATA

(71) Applicant: HEWLETT PACKARD ENTERPRISE DEVELOPMENT LP, Houston, TX (US)

(72) Inventors: Dexter Lloyd Fryar, Houston, TX (US); Flint M Calvin, Tumwate, WA (US); Daniel Dyer, Boise, ID (US)

(21) Appl. No.: 15/024,368

(22) PCT Filed: Oct. 29, 2013
(86) PCT No.: PCT/US2013/067302

§ 371 Date: Mar. 24, 2016

(51) Int. Cl. G06Q 30/02

(52) U.S. Cl. CPC G06Q 30/0246; G06Q 30/0244

(57) ABSTRACT

Metering real time service data includes advertising a promotion through an advertising medium, collecting usage metrics of the promotion, and presenting a real time report based on the usage metrics.

### BACKGROUND

A business may use a service provider to create a promotion, such as an advertisement that presents a discounted product or service over the internet. Such a promotion may be distributed by the service provider to potential customers over the internet, radio, television, or another distribution mechanism. The promotions may provide potential clients an incentive to purchase the product or service at a discounted price. The business may hope that as the customers use the product or service at the discounted price that the customer will want to use the product or service in the future. Thus, the promotion is a mechanism that the business can use to potentially increase their pool of customers.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a metering system according to the principles described herein.

FIG. 2 is a diagram of an example of a metering system according to the principles described herein.

FIG. 3 is a diagram of an example of promotion details according to the principles described herein.

FIG. 4 is a diagram of an example of a method for metering real time service data according to the principles described herein.

FIG. 5 is a diagram of an example of a metering system according to the principles described herein.

FIG. 6 is a diagram of an example of a metering system according to the principles described herein.

### DETAILED DESCRIPTION

When the usage metrics from a promotion are made available through a delayed-time collection, the business will not know its current charges or how many resources it has consumed until it gets an end of the month statement. Each service provider creates its own back-end processing solution and customer dashboard. These solutions are one-off systems that are integrated into respective accounting systems. From a usage perspective, each service offering is independently instrumented to produce key/value pairs in a deterministic manner.

A challenge with a distributed, large scale, virtualized product offering is handling the massive amount of measurement data and providing aggregated real time granular usage information. Such information can be aggregated into a searchable format that allows the user to search the data for desired information such as trends. In a batch processed model, the business has no real time knowledge of utilization. Other issues of batch operations include aged views of current burst trends. Thus, during the use of the promotion, the business is unaware of the promotion's effectiveness and how to customize the promotion to maximize profit and utilization during the promotion's run time.

The principles described herein include a real time solution that allows the customer to control costs, perform strategic planning, and provides real time revenue recognition to the business and the service provider. Another benefit realized through the real time metering solution is allowing businesses to meet end of month sales objectives by providing an ability to adjust the promotion during the promotion's run time. Without knowledge of the real time costs and utilization, a service provider has no reliable way for the customer to use potential promotions and pricing schemes to their benefit. When the usage is not available until an end of month statement is produced, the business is left with no other option apart from speculative scheduling based on historical data. Promotional service offerings cannot be easily utilized in such a case.

The principles described herein include a method for metering real time service data. Such a method may include advertising a promotion through an advertising medium, collecting usage metrics of the promotion, and presenting a real time report based on the usage metrics.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

FIG. 1 is a diagram of an example of a metering system (100) according to the principles described herein. In this example, a promotion service (102) sends a promotion (104) to a customer pool (106). The customer pool (106) responds by signing up for the product or service and using resources through the promotion service (102). The promotion service sends real time reports (108) to the client (110) who ordered the promotion.

The promotion service (102) may be a business that provides services to businesses or individuals to promote a product or service by offering a discount or other incentive. The promotion service (102) may generate the promotion based on information provided by the business or individual. Further, the promotion service (102) may distribute the promotion through any appropriate mechanism. For example, the promotion service (102) may advertise the promotion through the internet, a social media site, a blog, over the telephone, mailed flyers, newspaper ads, radio, television, another appropriate mechanism, or combinations thereof.

The customer pool (106) may include both current customers that already use the promoted product or service as well as potential customers that are not already using the product or service. In an example where a promoted product is a subscription to an online service, the current customers may respond to the promotion by logging into their customer accounts to take advantage of the promotion. Additionally, new customers may create new customer accounts to take advantage of the promoted service. The new user accounts and the resources used by the new and existing users can be tracked by collectors. This collected information may be sent back to the promotion service where the collected information is aggregated.

The aggregated data may be formatted to present the information in a useful way such as in a report format. For example, the aggregated data may be formatted to present to the client (110). Such a report (108) may be sent to the client (110) in real time as the data is collected. Such a report may also include types of information such as the number of promotions that were activated, the time when the promotions were activated, the number of current customers taking advantage of the promotion, the number of new customers creating accounts, the resource usage of the new customers, the resource usage of the existing customers, the geographic distributions of which customers are using the promotion, the distribution mechanism used by the customers, other details, or combinations thereof.

The real time report (108) provides the client (110) a view into how effective the promotion is and what factors are influencing the promotion's effectiveness. With such real time information, the client (110) is enabled to make decisions about the promotion while the promotion is still running. For example, if the promotion is meeting the client's goals, the client (110) may make no changes to the promotion. On the other hand, if the pace of the promotion is not going to help the client reach an end of month goal, the client (110) may make changes to the promotion based on the real time data in the report (108). For example, the real time report may indicate that the radio ads are not realizing many promotion activations while promotions distributed through a particular social media website have been very successful. As a result, the user may request that a similar social media website be used to promote the product or service while discontinuing the radio promotion distribution. The client (110) may also make changes to incentives with the promotion. If the promotion appears to be less effective than desired, the client (110) may cause the service provider (102) to increase the discount or other incentive associated with the promotion. On the other hand, if the promotion appears to be more effective than realized, thereby potentially causing the client (110) to run out of stock of the promoted client or lose money on the promotion, the client (110) may cause the service provider (102) to decrease the discount or the other incentive. While these examples have been described with reference to specific adjustments that a client (110) may make to a promotion based on the real time data provided in the reports (108), the client (110) may make any appropriate type of change based on the real time data and the client's goals in accordance with the principle described herein.

The real time data may also be presented to the service provider (102). The service provider (102) may also use the real time data to make determinations useful for providing the promotion service. For example, the promotion service may use real time data to understand if the promotion is reaching the milestones desired by the client (110). If the promotion is not reaching such milestones, the service provider (102) may make recommendations or send notifications to the client (110) about the client's options. In some examples, the service provider (102) may send a report in a notification or provide a mechanism to access such a report. The service provider (102) can also use the real time data to determine the service provider's real time costs.

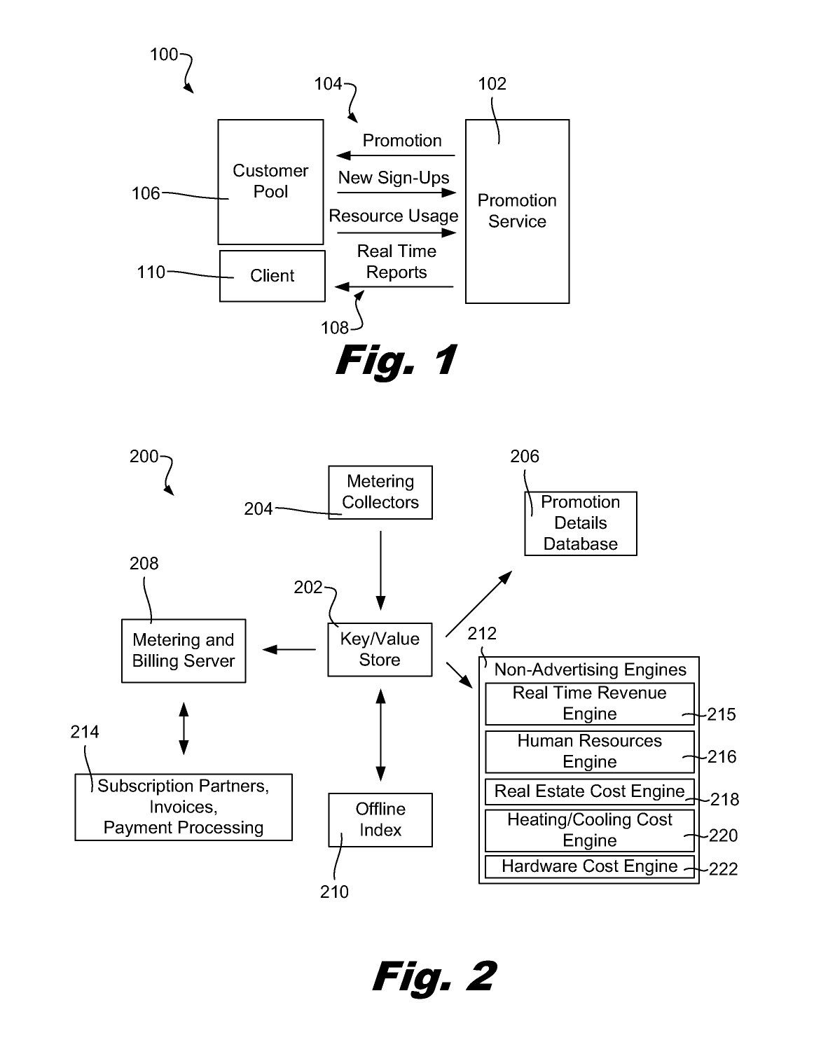

FIG. 2 is a diagram of an example of a metering system (200) according to the principles described herein. In this example, a key/value store (202) stores the collected information about the promotion. Such information is pushed to the key/value store (202) through metering collectors (204). The key/value store (202) may provide its information to a promotion details database (206), a metering and billing server (208), an offline index (210), and non-advertising engines (212).

In some instances, the distribution mechanisms may also be the metering mechanisms. For example, a social media website that distributes the promotion may also collect information about how the customers responded to the promotion. In other examples, external metering devices collect the information about how the customers respond to the promotion.

The principles described herein use a push-based metrics model to update the distributed key/value store in real time based on a configurable time delay for collection and updates. Each service offering collection endpoint is provided a configurable mechanism for pushing key/value measurement pairs to a global sink.

A configurable mechanism also allows distributed updates of secondary indices using an endpoint mechanism to push updates into wide rows. By utilizing secondary indices, reporting clients will have access to time series usage data by just performing a single row read. These principles may also use expiration timestamps on dispensable indices where data growing over time is purged without user intervention or data scrubbing. Service endpoints may push distribution mechanisms to preprocess and push key/value pairs derived from an external flat file and/or direct string/structure parameters to a global data store. Promotion identifiers can be used to uniquely identify specific promotions.

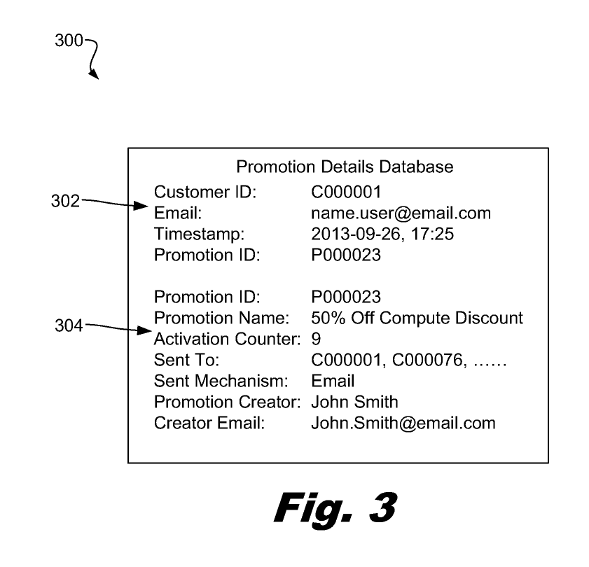

Details about the promotion may be tracked in the promotion details database (206). Using universally unique identifier (UUID) tokens provides explicit tracking results and in-depth knowledge about the effectiveness of a specific promotion. Other details about the promotion such as when the promotion is working, where the promotion is working, and what type of customers use the promotion can also be gleaned from the same mechanism because the promotion has a unique identifier. The granularity can be decided upon when setting up the promotions. More details about the promotion details database will be described later in conjunction with FIG. 3.

The information from the key/value store (202) may also be sent to the metering and billing server (208), which tracks billing information and usage information about the promotion. This server (208) may arrange the information into a format that is suitable to present to the client, prepare invoices, and provide payment options. These services may be sent to devices (214) belonging to the client, such as payment processes, subscription processes, invoice devices, other devices, or combinations thereof.

The offline index (210) may collect the data and customize the format of the data based on user input. For example, if a client has a specific calculation that it wants performed on its data, the key/value store (202) can send the data to one of several off line indexes where such data processing can take place. This information may be sent to the user using a batch model to supplement the real time data presentation.

The non-advertising engines (212) may include engines that are used by the service provider, but are not involved in advertising. The service provider may also benefit by sending the real time data about the promotions to these engines to determine in real time the costs associated with the promotion. For example, the real time data may be sent to real time revenue engines (215), human resource engines (216), real estate cost engines (218), heating/cooling cost engines (220), and hardware cost engines (222).

FIG. 3 is a diagram of an example of promotion details (300) in a promotion details database (206, FIG. 2) according to the principles described herein. In this example, information about a customer and a promotion are depicted.

The customer information (302) includes a customer identifier and an email address for the customer. A timestamp is included for a time when the customer activates the promotion. In this example, there is a single timestamp displayed. In other examples, there is a timestamp for each time that a customer activates the promotion. Also, a promotion identifier is included with the timestamp to indicate which of the promotions was activated. While this example has been described with reference to specific customer information that is stored and tracked, any appropriate type of information about the customer may be stored and tracked in accordance with the principles described herein.

The promotion information (304) includes the promotion identifier and a name of the promotion. A counter tracks the number of times that the promotion has been activated. Further, the promotion information tracks to whom the promotion was sent with the corresponding distribution mechanism for sending the information. The promotion's creator is also tracked as well as the creator's email. While this example has been described with reference to specific promotion information that is stored and tracked, any appropriate type of information about the promotion may be stored and tracked in accordance with the principles described herein.

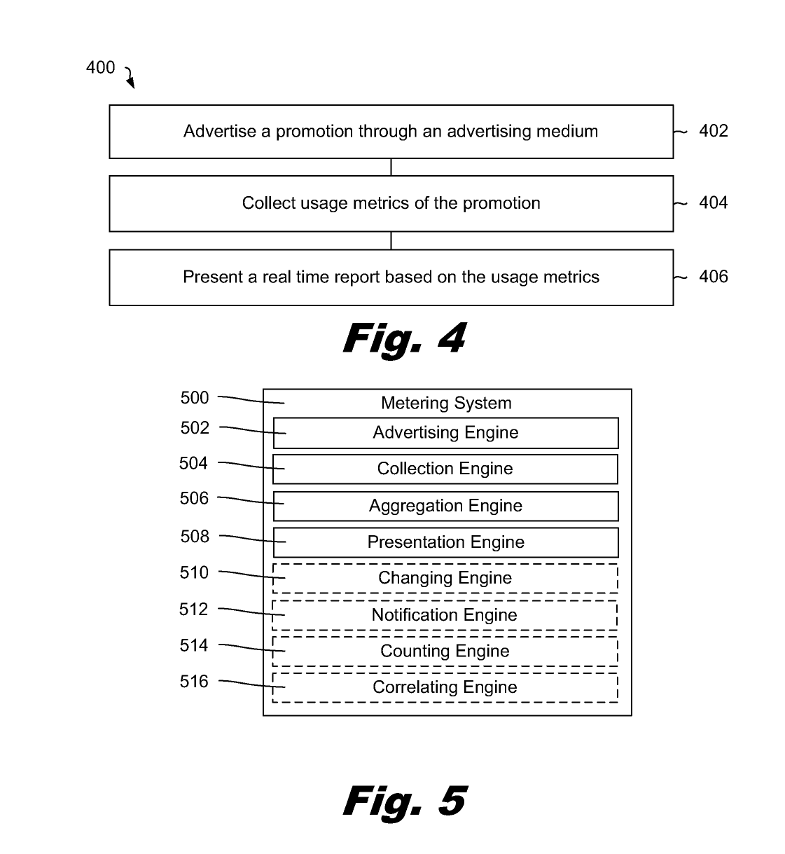

FIG. 4 is a diagram of an example of a method (400) for metering real time service data according to the principles described herein. In this example, the method (400) includes advertising (402) a promotion through an advertising medium, collecting (404) usage metrics of the promotion, and presenting (406) a real time report based on the usage metrics.

The real time report may include real time data or near real time data. Near real time data may include data that is processed as it is collected, but due to processing, latency, or other factors, the presentation of the data is delayed from the time that the data is actually collected. The advertising media may include distribution mechanisms, such as social media sites, radio, television, internet, newspaper ads, other advertising mechanisms, or combinations thereof. The usage metrics may include the number of times that a promotion is activated, the number of times that a particular customer activates the promotion, the number of new customers using the promotion, the number of existing customers using the promotion, the time that the promotions are used, the geographies and/or demographics of the customers when they active the promotion, other information, or combinations thereof.

The principles described herein provide real time usage metrics to the end user and revenue recognition systems for cloud service offerings. These principles include a push based metrics collection system which facilitates client/service tunable metrics delivery and eliminates having to rely on background batch processing for base usage. This system implements a key/value metrics approach which provides an extensible service offering by using a dynamic column store with secondary indices for fast real time data access. End users can leverage near real time metrics to control their costs.

The principles described herein provide the granular visibility to promotions which can be slowed down by decreasing the promotion's incentive when the promotion reaches an effectiveness threshold. Automated high watermark notifications can be provided to the customer for usage and cost concerns. Real time revenue reporting can be implemented with a dashboard to report time based queries to observe current usage. Empirical product and promotion testing could be done on an ad-hoc basis to help drive and understand future decisions on the service offering. Ad-hoc promotions for underutilized services and/or resources could be offered which might facilitate meeting quarterly goals. Promotional offerings, product pricing increases/decreases (as energy costs or system utilization changes) may also be achieved with the principles described herein.

FIG. 5 is a diagram of an example of a metering system (500) according to the principles described herein. In this example, the metering system (500) includes an advertising engine (502), a collection engine (504), an aggregation engine (506), and a presentation engine (508). In this example, the metering system (500) also includes a changing engine (510), a notification engine (512), a counting engine (514), and a correlating engine (516). The engines (502, 504, 506, 508, 510, 512, 514, 516) refer to a combination of hardware and program instructions to perform a designated function. Each of the engines (502, 504, 506, 508, 510, 512, 514, 516) may include a processor and memory. The program instructions are stored in the memory and cause the processor to execute the designated function of the engine.

The advertising engine (502) advertises the promotions through an advertising medium. In some examples, the advertising engine (502) selects the advertising medium on which to advertise the promotion. In other examples, the advertising medium is selected based on user input.

The collection engine (504) collects usage metrics based on the activation of the promotion. The collecting engine (504) may have physical or virtual devices that are integrated with the advertising medium that collect information as the promotions are selected. In some examples, the collection engine (504) retrieves information from the advertising medium. The collection engine (504) may cause one or multiple entities to send collected data to a storage unit, such as the key/value store (202, FIG. 2) where the data may be available for various processing and/or safe keeping.

The aggregation engine (506) aggregates the data collected from the collection engine (504) and organizes the data into a useful format, such as into a report for the end user. The presentation engine (508) presents the data to the customer.

The changing engine (510) allows the user to change the promotion based on the real time information. Often, a promotion service will include running a promotion for a certain amount of time. However, the changing engine (510) allows the user to change the details of the promotion before the originally predetermined end period of the promotion's run time. In such an example, a user may access a user interface to pull up the promotion's parameters and make changes. The user may change the price, incentives, the advertising medium, the target demographics, the target region, the promotion's designated ending time, or other parameters about the promotion.

The notification engine (512) notifies the user or the service provider about real time information. In some examples, the notification engine (512) provides a uniform resource identifier (URI) where the user or service provider can look up the details about a particular promotion. In such an example, the details about the promotion are presented as the information is collected, thus in real time. In other examples, the notification engine (512) sends a report or a notice to the user as the promotion reaches certain milestones or thresholds. For example, a notification may be sent in response to achieving a certain threshold of users that have activated the promotion. In other examples, a notification may be sent in response to achieving a certain number of activations within a predetermined time period. The notification engine (512) may also send a notification in response to a time lapse from the initiation of the promotion. For example, the notification engine (512) may send a notification to the user in response to half of the promotion's run time having passed. The notification may also be sent at different predetermined thresholds or milestones. The notification engine (512) may send recommendations or options for how to change the promotion based on the real time data and the service provider's understanding of what the end user wants to accomplish with the promotion.

The counting engine (514) may count the number of times that a promotion is activated. The count may be included in the real time data presented to the end user.

The correlating engine (516) causes the real time data to be correlated with the other engines that are used by the service provider. In this manner, the service provider can determine if or how the promotion's usage metrics affect other systems run by the service provider.

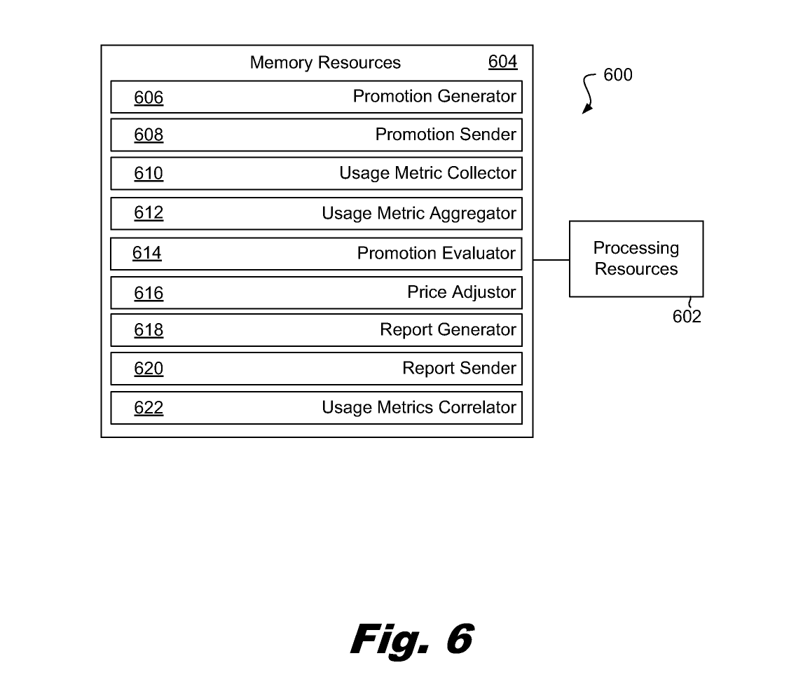

FIG. 6 is a diagram of an example of a metering system (600) according to the principles described herein. In this example, the metering system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the metering system (600). The programmed instructions shown stored in the memory resources (604) include a promotion generator (606), a promotion sender (608), a usage metric collector (610), a usage metric aggregator (612), a promotion evaluator (614), a price adjustor (616), a report generator (618), a report sender (620), and a usage metrics correlator (622).

The memory resources (604) include a computer readable storage medium that contains computer readable program code to cause tasks to be executed by the processing resources (602). The computer readable storage medium may be tangible, non-transitory, and/or ephemeral storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, magnetic storage media, other types of memory, or combinations thereof.

The promotion generator (606) represents programmed instructions that, when executed, cause the processing resources (602) to generate a promotion based on user input. The promotion sender (608) represents programmed instructions that, when executed, cause the processing resources (602) to send the promotion to a customer pool. The usage metric collector (610) represents programmed instructions that, when executed, cause the processing resources (602) to collect metrics about the customers response to the promotion.

The promotion metric aggregator (612) represents programmed instructions that, when executed, cause the processing resources (602) to aggregate the collected metric data. The promotion evaluator (614) represents programmed instructions that, when executed, cause the processing resources (602) to evaluate the promotion's real time data. In some examples, the notification is sent to the user based on the promotion evaluator's findings.

A report generator (618) represents programmed instructions that, when executed, cause the processing resources (602) to generate a report based on the collected real time data, and in some cases the evaluation of the collected data. The report sender (620) represents programmed instructions that, when executed, cause the processing resources (602) to send the report to the end user. The price adjustor (616) represents programmed instructions that, when executed, cause the processing resources (602) to allow the user to adjust the price of the promotion. The end user may desire to adjust the price depending on how effective the promotion appears to be based on the collected real time data.

The usage metrics correlator (622) represents programmed instructions that, when executed, cause the processing resources (602) to correlate the collected promotion data with the data of other systems being monitored by the service provider. In some examples, the other systems can also collect real time data which can be correlated with the real time promotion data.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries and may be accessed from a remote location over a network connection while the programmed instructions are located locally. Thus, the metering system (600) may be implemented on a user device, on a server, on a collection of servers, or combinations thereof.

The metering system (600) of FIG. 6 may be part of a general purpose computer. However, in alternative examples, the metering system (600) is part of an application specific integrated circuit.

While the examples above have been described with reference to specific mechanisms for advertising and distributing the promotion, any appropriate mechanism for advertising and/or distributing the promotion may be used. Also, while the examples above have been described with reference to specific mechanisms for collecting the usage metrics, any appropriate mechanism for collecting the usage metrics may be used in accordance with the principles described herein.

Further, while the examples above have been described with reference to specific mechanisms for how the collected usage metrics are used, any appropriate mechanism for using the usage metrics may be used in accordance with the principles described herein. Additionally, while the examples above have been described with reference to specific mechanisms for how and when to present reports or notifications based on the collected real time data, any appropriate mechanism for how and when to present reports or notifications based on the collected real time data may be used in accordance with the principles described herein.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A computer program product for metering real time service data, comprising:
a non-transitory computer readable storage medium that comprises program instructions that, when executed, cause a processor to:
advertise a promotion through an advertising medium;
collect usage metrics of said promotion; and
present a real time report based on said usage metrics.

2. The computer program product of claim 1, further comprising program instructions that, when executed, cause said processor to change said promotion based on said usage metrics.

3. The computer program product of claim 1, further comprising program instructions that, when executed, cause said processor to increase a price associated with said promotion.

4. The computer program product of claim 1, further comprising program instructions that, when executed, cause said processor to decrease a price associated with said promotion.

5. The computer program product of claim 1, further comprising program instructions that, when executed, cause said processor to present said real time report to a customer.

6. The computer program product of claim 1, further comprising program instructions that, when executed, cause said processor to send real time notifications about said usage metrics to a customer.

7. The computer program product of claim 1, further comprising program instructions that, when executed, cause said processor to use a counter to count a number of times said promotion is activated.

8. The computer program product of claim 1, further comprising program instructions that, when executed, cause said processor to aggregate said usage metrics into a searchable format.

9. The computer program product of claim 1, further comprising program instructions that, when executed, cause said processor to correlate said usage metrics with data from non-advertising engines.

10. A system for metering real time service data, comprising:
an advertising engine to advertise a promotion through an advertising medium;
a collecting engine to collect usage metrics about said promotion;
an aggregation engine to aggregate said usage metrics into a searchable format; and
a presentation engine to present a real time report based on said usage metrics.

11. The system of claim 10, further comprising a changing engine to change said promotion based on said usage metrics.

12. The system of claim 10, further comprising a notification engine to send notifications about said usage metrics to a customer.

13. The system of claim 10, further comprising a counting engine to count a number of times said promotion is activated.

14. The system of claim 10, further comprising a correlating engine to correlate said usage metrics with data from non-advertising engines.

15. A method for metering real time service data, comprising:
advertising a promotion through an advertising medium;
collecting usage metrics about said promotion;
aggregating said usage metrics into a searchable format; and
changing said promotion based on said usage metrics.
